(19) United States
(12) Patent Application Publication
(10) Pub. No.: US 2013/0290027 A1
(43) Pub. Date: Oct. 31, 2013

(54) ELECTRONIC MEDICAL RECORDS SYSTEM WITH ACTIVE CLINICAL GUIDELINES AND PATIENT DATA

(71) Applicant: EPIC SYSTEMS CORPORATION, Verona, WI (US)

(72) Inventors: Paul C. Tang, Los Altos, CA (US); Charles Y. Young, Palo Alto, CA (US); Samuel LeRush Butler, Madison, WI (US); Jeffrey D. Miles, Madison, WI (US)

(21) Appl. No.: 13/917,835

(22) Filed: Jun. 14, 2013

Related U.S. Application Data
(63) Continuation of application No. 11/047,277, filed on Jan. 31, 2005.
Application No. 11/047,277 is a continuation-in-part of application No. 09/524,826, filed on Mar. 14, 2000, now Pat. No. 7,383,196.

(51) Int. Cl. G06F 19/00; G06Q 50/24

(52) U.S. Cl. CPC G06F 19/322; G06Q 50/24
USPC 705/3

(57) ABSTRACT

An active guidelines capability or component is linked to a computerized patient record system to integrate the use of clinical guidelines in the workflow of clinicians treating patients. Many healthcare entities maintain sets of clinical guidelines describing recommended treatment or analysis options for patients displaying sets of symptoms or for whom certain diagnoses have been made. The active guidelines feature adds an active guidelines tag to such clinical guidelines so that when the clinician accesses the clinical guidelines and wishes to follow the recommendation, the clinician merely has to click on a hypertext created from the tag which then transmits action orders, also contained in the tag, to be transmitted to the computerized patient record system for implementation. Patient data associated with the recommendations, such as relevant test or lab results, interaction or allergy information, or other current treatments, is also identified and displayed.

### CROSS-REFERENCE TO RELATED APPLICATIONS

This application is a continuation of U.S. patent application Ser. No. 11/047,277, filed Jan. 31, 2005, entitled “ELECTRONIC MEDICAL RECORDS SYSTEM WITH ACTIVE CLINICAL GUIDELINES AND PATIENT DATA,” which is a continuation-in-part of U.S. patent application Ser. No. 09/524,826, filed Mar. 14, 2000, entitled “ELECTRONIC MEDICAL RECORDS SYSTEM WITH ACTIVE CLINICAL GUIDELINES,” the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

When patients are seen, treated, or tested by medical practitioners and technicians, the events of the interaction are recorded by the medical professionals. Those recordings become part of the patient's medical record. The maintenance of these medical records for a patient are an essential part of modern medical treatment of the patient. Recently, the technology of recording and archiving medical records has undergone a dramatic evolution. Instead of the previous bulky paper recording systems, modern medical and health care entities are adopting electronic medical records systems, sometimes also known as computerized patient records systems. Such computerized record keeping systems offer significant advantages to the practitioners and to the patient, as well as to the health care entity as a whole.

Electronic medical records systems are typically accessible by clinical service providers from throughout the health care entity, without the need for tracking down a particular paper file. Electronic medical records make it easier to track orders and results and to ensure that orders and results are flagged for the attention of the appropriate health care professional. An electronic medical records system may provide for a centralized repository of the health care records of the patient allowing for immediate access regardless of the patient's location. This allows all healthcare professionals seeing the patient to more easily and readily be aware of particular medical conditions, and avoids the need to transfer and maintain paper files around the entity. From the viewpoint of the health care entity, electronic capture and analysis of patient visits, diagnoses, treatments, and results information make possible the realistic evaluation of clinical outcomes in view of any desired input parameter. As a result, the use of electronic medical records continues to rapidly grow.

Many medical and health care entities also maintain a set of clinical practice guidelines for the benefit of health care providers. Such clinical guidelines are not intended to prevent a practitioner from exercising the necessary judgment in treating a particular patient, but are intended to provide a common framework throughout the entity for the diagnosis and treatment of common medical problems in a relatively consistent manner. For example, a pediatric practice might have a clinical guideline for the evaluation, initial treatment, and then for the escalation of treatment if unsuccessful, for childhood earaches. Such protocols are recorded in a form accessible throughout the entity so that the health care providers can refer to those guidelines in making actual decisions on patient care. In the past, such clinical guidelines were often distributed in booklet or written form, and now they are often made available by computerized access.

While the use of clinical guidelines sounds in theory to be a very practical idea, the manner in which such guidelines are implemented often leaves the guidelines out of the normal workflow of the clinical service providers. All of the health care workers in an entity, including physicians, nurses, technicians, aides, and assistants, are typically very busy and their time is often tightly scheduled. Therefore, while taking time to refer to a published set of clinical guidelines does not in theory sound like a great burden, in the life of a busy clinician seeing patients, if a referral to the clinical guidelines is not convenient to make in the normal workflow for the clinician, the reference to the clinical guidelines may not be made.

This is true even in environments in which all the information is in electronic form. For example, like other entities, health care entities often now maintain an intranet in which information is posted for access around the entity in electronic form. In such an intranet, the users of the systems typically use a form of a web browser program, such as Netscape Navigator or Microsoft Internet Explorer, to navigate around and find information in the entity's intranet. However, when those same clinicians are updating the medical records for a patient, those users are typically not using the web browser program of the entity, but are typically using the electronic medical records system software for the entity. Typically, the only way available to transfer information from the clinical guidelines into a medical record is to physically transcribe the information for later entry into the medical records system. In part, this is because of the format of typical intranet (or internet) web pages, which are generally composed in HTML or (in the future) XML syntax, while the medical records systems use their own unique forms of data structure and information formatting.

Because clinical guidelines apply generally to a particular type of diagnosis, a variety of treatments or recommendations for further treatments may be provided, not all of which may apply to a particular patient. For example, a recommended medication may have a negative interaction with a medication the patient is currently taking or the patient may be allergic to certain types of medication. Relating to recommendations for testing, the patient may have already had certain tests performed that appear in the list of recommendations. To effectively use the clinical guideline, the clinician must refer back to the patient's medical record for specific information that may impact the decision whether to implement one or more of the recommendations present in the clinical guideline. This cross-referencing may be cumbersome or time consuming for the clinician, which may lead to a lower utilization of the clinical guidelines.

Accordingly, what is needed is a method to more easily integrate an entity's clinical guidelines into the normal workflow for the clinicians actually charting the patients' medical records.

### BRIEF SUMMARY OF THE INVENTION

The present invention is summarized in that the active guidelines for a health care entity are typically published in a web format, such as HTML or XML. Also incorporated into the documents containing the guidelines is a set of active guideline tags specifying actions to be taken in an electronic medical records system. The active guideline tags are presented in the display to the user in the same format used to present a universal resource locator (URL) address, i.e. appearing like a typical hyperlink to a web page. The clinician when viewing the active clinical guidelines can then activate the action items by invoking the hyperlink as it appears on his or her computer screen. The active guideline tag underlying the hyperlink is then transmitted to the electronic medical records system, both for incorporation into the patients medical record and to initiate the requested action. Along with the hyperlinks for initiating orders, data from the patient record relevant to the recommended actions is also displayed. What data is displayed is configurable on the system, department, user, or other levels as defined by the facility. Patient data may be gathered regarding relevant test or lab results, interaction or allergy information, other current treatments, etc.

The medical records system thus constructed is intended to incorporate the ability to use practice guidelines into the everyday workload of the healthcare personnel and the related creation of medical records. The clinician can, with little more than the click of a computer mouse, import action items derived from the active guidelines web pages which are then transferred as a whole into action items in the electronic medical records system. Thus not only are the practice guidelines incorporated into the everyday work flow, but the use of the protocol or treatment plan suggested in the clinical guidelines becomes easier to do than doing something else, thus encouraging utilization of the guidelines themselves. The patient data further enhances the clinical guideline because relevant data can be viewed and accessed within the guideline without requiring the clinician to transition between the guideline and the patient record. This improves both patient safety and clinician efficiency.

It is an advantage of the present invention that it permits the active guidelines to be viewed by web browsers not embedded in medical records systems without the users being aware that there is anything that they are not seeing.

Other objects, advantages and features of the present invention will become apparent from the following specification when taken in conjunction with the accompanying drawings.

### BRIEF DESCRIPTION OF THE SEVERAL VIEWS OF THE DRAWINGS

FIG. 1 is a schematic illustration of the logic of data flow for an embodiment of the present invention; and

FIG. 2 is a simplified diagram illustrating a display for integrating clinical guideline recommendations and related patient data.

FIG. 3 is a simplified diagram illustrating a display of patient look back data.

### DETAILED DESCRIPTION OF THE INVENTION

This invention is generally directed to integrating the use of clinical guidelines at a health care entity into the use of an electronic medical records system, and more specifically, to allow patient data related to a particular clinical guideline to be identified and displayed concurrently within the clinical guideline. To accomplish that objective, the clinical guidelines are made “active,” meaning that the guidelines have embedded in them active commands that can be interpreted by an electronic medical records software system. It is preferred that the guidelines be displayed in the form of an otherwise normal appearing web page, whether on an intranet or through internet access. The web page containing the clinical guidelines contains within it an active guideline tag containing series of active instructions that can be interpreted by an electronic medical records system. When the user of the system is in the process of charting for the patient, the clinician can actually implement various kinds of orders, for example for lab tests or to prescribe drugs, by simply accepting and thus implementing, the action recommendation contained in the tag associated with the clinical guideline appropriate for that patient. Along with the action recommendation, the clinical guideline display may include, if present, patient data that may impact the clinician's decision to implement the recommendation. It may also include an indication that limited or no data is present.

The conventional practice at larger health care entities or departments of such entities today is to post the clinical guidelines on a web page accessible by computer network from anywhere in the entity, or at least anywhere in the department. The web page is therefore typically a document composed in HTML format, although the use of other formats, and in particular the use of XML format, is specifically envisioned. The electronic medical records system should have embedded in it a web browser capability. The term web browser is meant to represent an application capable of interpreting documents encoded using common platform independent formats, such as HTML or XML, that are commonly used for browsing documents on the internet. The viewing application need not be able to actually access the internet, only interpret the documents. The difference in an active guidelines architecture is that the guideline document also includes a special coding for initiating action items in the medical records system included with each guideline. The active guidelines architecture also gathers patient data relevant to the action items from the medical records system and displays the patient data concurrently with the action items in an efficient manner that doesn't interfere with the guideline. The action item coding is interpreted by an active guideline interpreter which presents an image or text to the user with an associated URL pointer. It is a feature of this approach that it can be implemented in a manner that conventional browser programs, i.e. ones without the active guidelines capabilities, can still view the guidelines as web documents without any awareness that any capabilities are unavailable to such viewers.

It is envisioned that this invention is to be used with an electronic medical records systems, also known as a computerized patient records system, terms which are used here synonymously. The medical record system should also have clinical physician/provider order entry (CPOE) functions, such as order processing or prescription generation capabilities, although some in the field package these capabilities as separate products. This description also refers to web browsers, which is the common name in the industry for software capable of interpreting and presenting to the user information stored in HTML or XML format, typically through a TCP/IP interface. Since this invention is implemented mainly in computer software, it is intended that the illustrations and examples presented here be interpreted as exemplary of the underlying logic rather than as physical representations of the operation of a system embodying this invention.

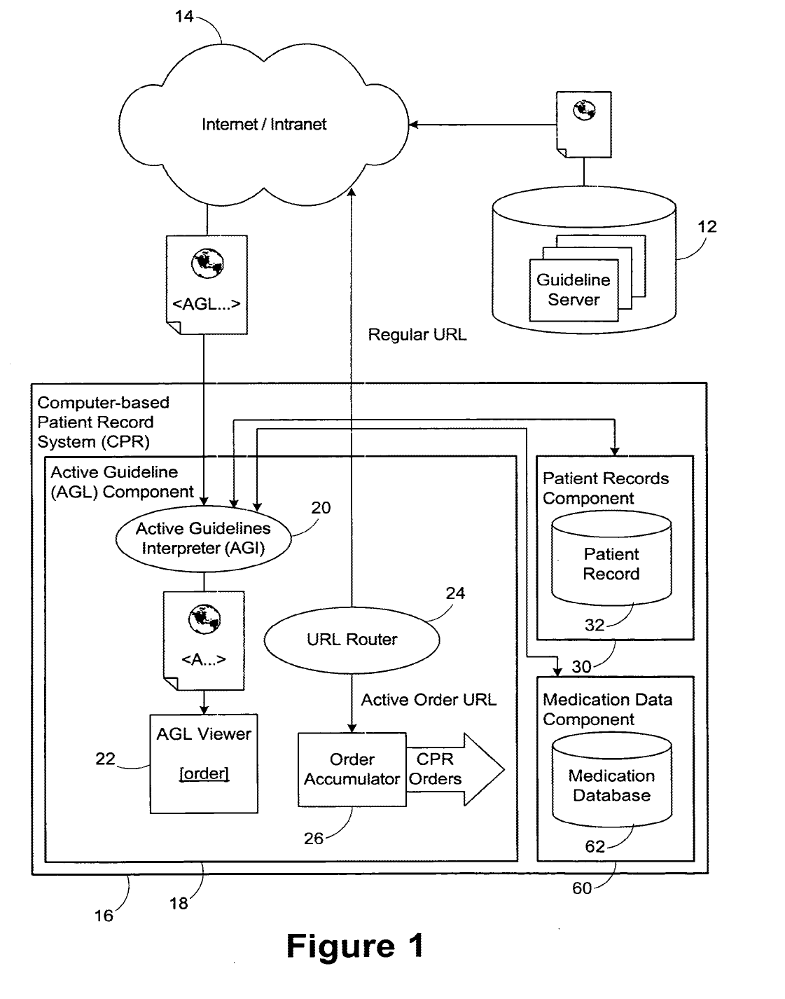

The conceptual schematic of FIG. 1 is intended to help explain the working of this embodiment. This embodiment is one intended to fit within the architecture of the EpicCare medical records system from Epic Systems Corporation of Madison, Wis. EpicCare has embedded within it a web browser software module, which gives the user web browsing and HTML interpretation capabilities while still in the EpicCare system. In this embodiment, the clinical guidelines of the entity reside on a guideline server indicated at 12. The guideline server 12 is simply a computer or processor with a storage device having the information representing the clinical guidelines stored therein. The guidelines are prepared and stored in the format of web pages, e.g. in HTML or XML format, with additional information attached to each guideline, as will be discussed further below. Communications between the user and the guidelines server can be through either an institutional intranet or through conventional internet connection, indicated at 14. At the work station of the user of the system, a computer or processor-based system is operating a computerized medical records system, indicated by the block at 16. This logical block 16 could, for example be the EpicCare computerized patient records system. Within the logical block 16 is another logical block labeled 18, representing the active guideline component of the system.

Within the active guideline component 18 is an active guideline interpreter 20, an active guideline viewer 22, and a URL router 24. The active guideline interpreter 20 is software which functions to parse the clinical guideline information and tags received from the guideline server 12 to convert the embedded guideline tags in the guideline document into a set of hyperlinks containing uniform resource locators (URLs). The active guidelines are then displayed by the active guideline viewer 22 on a display device accessible to the user in a format similar to common HTML web page documents.

Also within the logical block 16 is a logical block labeled 30, representing a patient data component of the system, and a logical block labeled 60, representing a medication data component of the system. The nested depiction of the blocks 16, 18, 30, and 60 is not intended to represent physical reality, but is intended to represent that the active guideline component 18, the patient data component 30, and the medication data component 60 are functions operating within, or called by, the computer-based patient record system 16.

There is a significant difference in how the active guidelines are displayed by the active guideline viewer 22, as compared to how the same guideline would be displayed by a conventional web browser not equipped for active guidelines. This difference might best be illustrated by a simplistic example. Consider a situation in which the clinical guideline is to recommend to the patient that he or she take two aspirin tablets each morning. In the conventional browser view, the user browsing the guidelines sees just the medical action suggested itself, i.e.:

TAKE TWO ASPIRIN DAILY

In the browser view using the active guideline interpreter and viewer, the user see the same recommendation to direct the patient to take two aspirins, but in addition is presented with a hypertext link, such as:

TAKE TWO ASPIRIN DAILY or

TAKE TWO ASPIRIN DAILY [ORDER]

The underlined phrases represent a word or phrase presented to the user appearing as a hypertext link in the browser. The browser will ignore the tags, but it will still leave the text within the tags. The hyperlink word of phrase could be the actual word “order” or “accept” to indicate acceptance of the clinical guidelines or could be a word or phrase describing the action to be take, i.e. “Recommend two aspirin.” If the clinician intends to follow the recommendation in the clinical guideline, that clinician merely needs to invoke the hypertext link, typically by clicking on the hypertext words with the computer mouse. This gives the user of the system the ability to simply click on the hypertext link to “order” to initiate a series of action orders which are transmitted to the electronic medical records system to electronically commence the action sequence recommended in the clinical guidelines, in this case to recommend the taking of two aspirin daily. The information is also entered into the patient's medical record. This is why the term “active guidelines” is used, since this gives the user of the system the ability not only to view the clinical guidelines of the entity but also, by the click of a single mouse stroke, to initiate the recommended procedure.

Upon retrieving an active guideline from the guideline server 12, the electronic medical records system 16 interprets each recommendation in the clinical guideline and identifies patient data relevant to the recommendation. When an active clinical guideline is established, the developer may specify patient data parameters related to the recommendations contained therein. For each procedure that may be ordered, a list of relevant test procedures may be specified. Typically, such lists are maintained as part of the electronic medical records system, so they need not be defined in the active guideline document. The centralized list may be accessed based on the recommended procedure to identify the relevant procedures. A look back window may also be specified in the active guideline, where only the results of tests performed later than the start time of the look back window are retrieved. For recommendations involving medications, the developer may specify various look back information items. An exemplary, but not exhaustive, list of look back parameters related to medications includes:
Relevant medications by therapeutic class
Relevant medications by pharmaceutical class
Drug/Drug interactions
Drug/Allergy interactions
Duplicate Therapy Alerts

Prior to displaying the active guideline, the medical records system 16 interprets the patient data parameters specified for the recommendations and retrieves the appropriate look back data from the patient data component 30 and the medication data component 60. The active guidelines interpreter 20 may pass patient look back parameters to the patient records component 30, which gathers the relevant patient data from the patient record 32. The look back data is then displayed in conjunction with the active clinical guideline and associated order hyperlinks. To identify the medication look back parameters, the patient's current medications and medications recommended in the active clinical guideline may be passed to the medication data component 60, which checks against a medication database 62 to identify data related to the items listed above. Medication databases that provide the requisite interaction data are well known to those of ordinary skill in the art and are commercially available. Accordingly, the construct and operation of the medication database 62 is not described in greater detail herein.

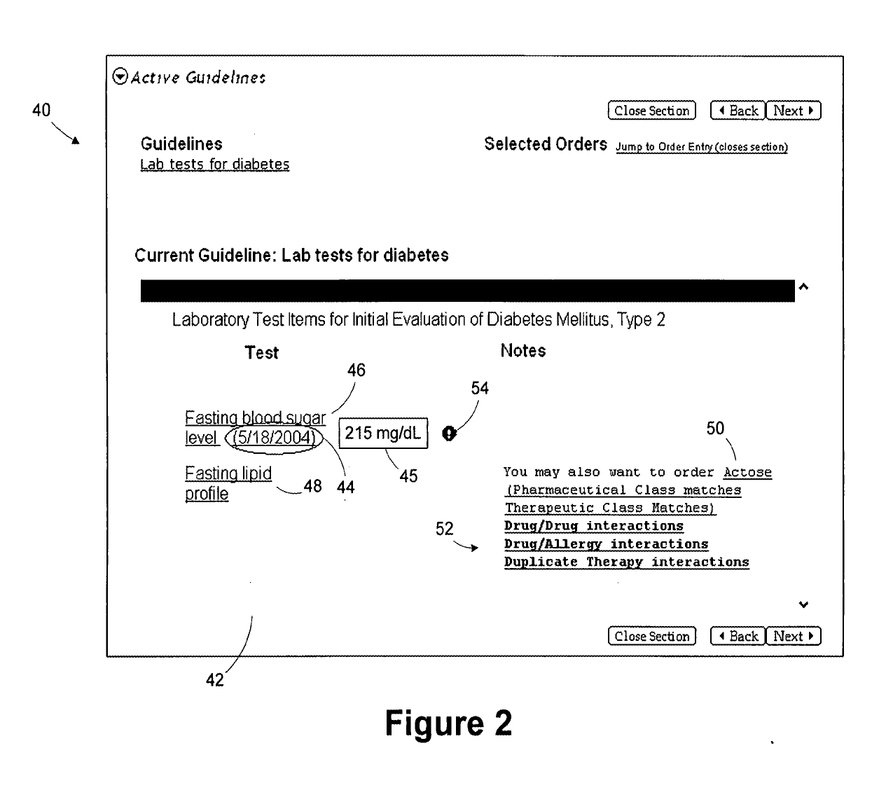

FIG. 2 illustrates an exemplary display 40 for an active guideline with patient look back data. In the example illustrated in FIG. 2, an active guideline related to diabetes is displayed in a guideline window 42. For diagnosing diabetes, tests such as fasting blood sugar levels and fasting lipid profiles have been determined to be useful by the medical professionals that created the active guideline. For the current patient, a fasting blood sugar level was tested on May 18, 2004. The clinician may access the data for that particular test by hovering the mouse pointer over the test data link 44, whereby the test results would be displayed in a tooltip (i.e., a standard HTML control). Alternatively, the user may click on the test data link 44 and transition to the patient record to see the full test report. In another embodiment, a data window 45 may be displayed next to the test data link 44 with the value of test parameter displayed therein.

If the clinician would like to order a new fasting blood sugar level test to get more recent data, the test can be ordered by clicking on the test order link 46. Note that the patient does not have recent data (i.e., within a specified look back window) for a fasting lipid profile. The clinician may order a fasting lipid profile by clicking on the test order link 48.

One recommended medication for treatment of diabetes is Actose. The clinician may order this medication by clicking on the medication order link 50. However, there is some information in the patient record that the clinician may want to consider prior to ordering Actose as indicated by the medication alert links 52. A pharmaceutical or therapeutic class alert may be generated if the patient is already on a medication in the same pharmaceutical or therapeutic class and the clinician may not need to prescribe any additional medication. Based on the patient record 32, issues related to drug/drug interactions, drug/allergy interactions, and duplicate therapy interactions, have been identified. Accordingly, responsive to identifying an alert condition, the links to these items have been highlighted using a bold typeface. Other exemplary techniques for highlighting the links include, but are not limited to, changing the color of the text (e.g., to red), causing the text to flash, or increasing the font size relative to the other text. For display space reasons, the actual information related to the interactions may not be displayed, but rather links to the detailed information may be provided. In other embodiments, additional data frames may be provided for showing the data. The user may access the data by hovering and receiving tooltip data or by clicking on one of the links 52. Links may be provided using hyperlinked text or icons. In some embodiments, the user may establish preferences where low risk data, such as low risk drug food interactions are not displayed.

At a systems level, when the user clicks on a hyperlinks for an “[ORDER]” (see FIG. 1), the active guideline viewer 22, which is again essentially a web browser, transmits the URL address which underlies the [order] hypertext on which the user has clicked. That URL is passed to the URL router 24, which has been programmed to pass on non-active guidelines URL web browsing requests out to the intranet or internet, but which intercepts URL requests that represent active guideline tags that are to be routed to the patient records system. The active guideline tags thus intercepted are interpreted back, to recover the actual medical records instructions and information associated with the clinical guidelines, and those instructions are accumulated (logically if not physically) in an order accumulator 26. The accumulated orders are transferred periodically, or upon user action, to the electronic medical records system to both update the patient's chart and to create electronic orders to initiate the actions actually requested by the user. Another way to look at this system is to consider what information resides or is transmitted at each stage of the use of this system. In the active guideline server 12, the clinical guidelines themselves are stored as text in storage associated with the server. The text of the guidelines includes information about actions or orders which are recommended based on certain diagnoses or conditions of the patients. The guidelines can include both action items, such as prescriptions, diagnostic tests, or various other forms of therapeutic treatments as well as text to be inserted into the patients medical records. For each action item, look back data parameters are also specified, indicating what data should be retrieved for the action item.

Associated with each clinical guideline in the server is an embedded active guideline tag. Such tags contain information which would need to be transferred to the computerized patient record system in the event that the user elects to follow a recommendation in the clinical guideline. The tag can therefore be a series of computer codes, text, data or instructions of whatever kind, or a combination of these elements, which can be recognized or processed by the computerized patient record system.

In normal web browsing, when the user requests to view a particular clinical guideline, the user does so by clicking on a hyperlink displayed on the user's display. Clicking on a hyperlink causes the web browser, in this case the active guidelines viewer, to generate a request to retrieve the HTML page associated with the underlying URL in the hyperlink. That request is sent through the intranet or internet to the active guideline server 12. The active guideline server 12 accesses the data storage associated with that request and transmits to the user the text of the selected clinical guideline with the embedded active guideline tags. The active guideline and associated tags are received by the active guideline interpreter 20, which interprets the information so as to present to the viewer (and the user) the text of the guideline itself, as well as an acceptance indicator specified by the tags. The acceptance indicator is typically a hyperlink, such as a hyperlink display of a word such as “order.” The information from the active guideline tag is kept in the hyperlink and made available to the URL router 24 in case the user decides to invoke the recommendation made in the clinical guideline. If the user invokes the recommendation made in the clinical guideline, the URL router 24 takes the embedded information from the hyperlink and places it in the order accumulator 26 for processing by the patient records system.

To help in illustration of this system, consider another example. For this system to be implemented, the architects of the active guideline system need to develop a syntax for the medical orders which is compatible with patient record systems. So, as an example, if the clinical guideline is to include an order for the medication naproxen, the active guideline tag might read:

<AGL TYPE=“MED” Name=“NAPROXEN+125+MG/5ML+OR+SUSP”
NDC=“0054-3630-63” DoseStrength=“125+MG/5ML”
Sig=“2+TEASPOONSFUL+TWICE+DAILY” Dispense=“600”
Refill=“0” ShowTherClass=“Yes” ShowPharmClass=“Yes”
ShowDrugDrug=“Yes” ShowDrugAllergy=“Yes”
ShowDupTherapy=“Yes”>Order Naproxen 125 mg</AGL>

This exemplary active guideline order includes leading and trailing delimiters to help to identify this tag from other text. This tag also includes all of the information necessary to transmit to a pharmacy system or module all the information necessary to prescribe a medication for the patient. The tag also includes patient look back parameters for specifying whether the pharmaceutical class, therapeutic class, drug/drug, drug/allergy, and duplicate therapy checks should be performed on the patient record 32. The information in the tag can be converted to an order by the patient record system when the prescription is sent to pharmacy. The next to last greater than symbol (>) also precedes and identifies an acceptance indication of the medication that is associated with this embedded tag.

Consider another example, when a procedure is to be ordered. In this case, a format of an active guideline embedded tag might look something like the following:

<AGL TYPE=″PROC″ Name=″CHEST+X-RAY+1+VW″ CPT=″71010″
Priority=″ROUTINE+[2]″ Quantity=″1″
RelevantResults=″Yes″ Lookback=″30days”>Order a chest
X-Ray</AGL>

Again the tag includes leading and trailing delimiters to identify the tag from other information. The tag includes information on the procedure to be performed, including the name of the procedure, its CPT code for correct billing and insurance processing, a priority rating, a relevant results flag specifying that relevant data from the patient record 32 for this test should be gathered, and a lookback parameter specifying the length of the look back window. Again at the end of the tag, after the last greater than symbol (>) the display name for the procedure recommendation.

In the above examples, the active guideline interpreter 20 changes some text from normal text in a conventional browser to a hyperlink in an active guideline browser. The active guideline tags can also be specified in such a way that a hyperlink is inserted in an active guideline browser. The example below will insert a hyperlink (displayed as “[Accept]”) in the display created by the active guideline browser. A regular browser viewing the same page will not display the “[Accept]” text.

<AGL TYPE=″PROC″ Name=″CHEST+X-RAY+1+VW″ CPT=″71010″
Priority=″ROUTINE+[2]″ Quantity=″1″
RelevantResults=″Yes″ Lookback=″30days”
Text=”[Accept]” />

Images are treated the same way as text. The active guideline interpreter will insert a hyperlink image or convert a normal image into a hyperlink as appropriate. For example, if the text within the text attribute of the AGL tag is html for an image, that image will be inserted into the html of the AGL, as represented in FIG. 2 by the icon 54. The icon 54 may be linked to the test report.

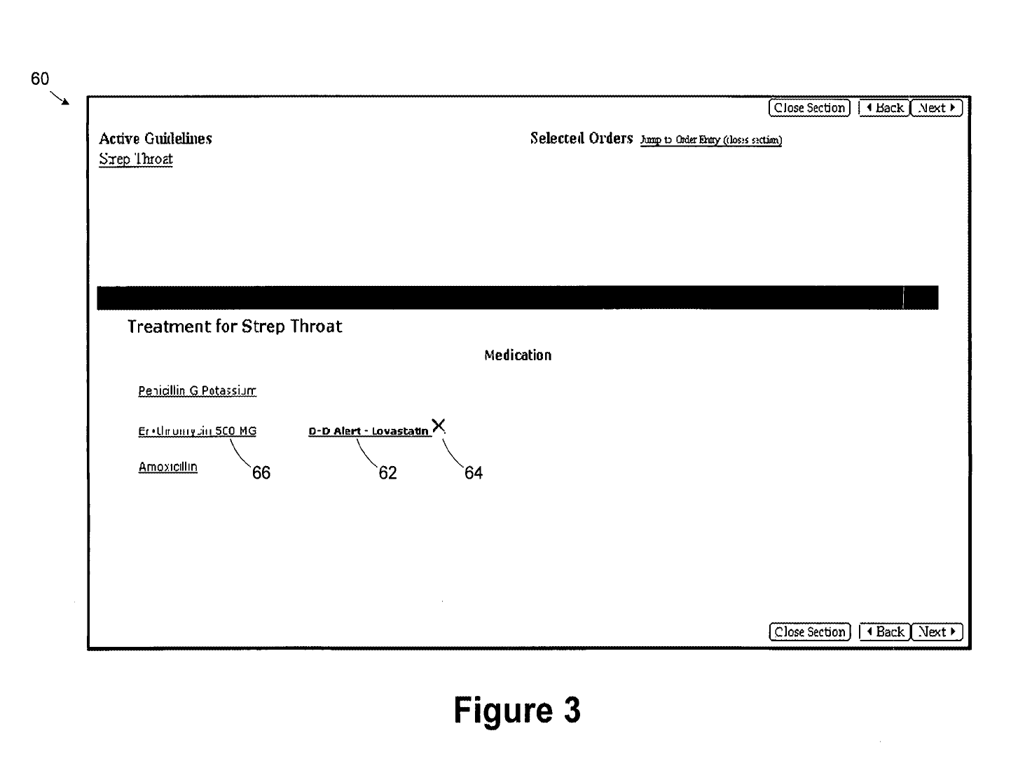

In another embodiment of the present invention, as illustrated by the display 60 shown in FIG. 3, the patient look back data may be used to identify a medication the patient is currently taking that should be discontinued in light of the treatment recommended in the active guideline. In the example, of FIG. 3, the patient is currently taking Lovastatin, a medication for treatment of elevated cholesterol level. The patient has currently been diagnosed with strep throat, for which the medication Erythromycin may be prescribed. However, as shown by an alert link 62, there is a drug-drug interaction alert for Erythromycin and Lovastatin. Hence, if the clinician wishes to order Erythromycin, Lovastatin should first be discontinued. A discontinue medication link 64 is provided such that the clinician can click on the link and enter an order for discontinuing the Lovastatin. Subsequently, the clinician may click on the order link 66 for Erythromycin to treat the strep throat.

In another similar example, the patient may already be taking an antibiotic for some other infection when the strep throat is identified. This antibiotic may not be a recommended or effective treatment for strep throat, but the Erythromycin may be sufficient to treat both infections. Hence, the clinician may discontinue the first antibiotic and order Erythromycin as described above for the drug interaction example.

In a case where a medication is to discontinued, an exemplary format of an active guideline embedded tag may be:

<AGL Type=“MED DC” MEDID=“12345”>Text or image</AGL>

In the active guideline interpreter 20, the active guideline tags are received from the guideline server 12 and processed for presentation to the user of the system. This processing, in essence, converts the tag information to a simple hyperlink representation presented to the user while maintaining the details of information in the hyperlink in a non-displayed format. For example, the active guideline tag above for the prescription for naproxen might be processed by the active guideline interpreter to create an active guideline hyperlink that might read as follows:

<A HREF=CPR:/agl/Order.asp?Type=MED&Name+Naproxen
+125+MG+OR+SUSP&NDC=0054-3630-63-&DoseStrength+
125mg/5ml&Sig=Take+2+Teaspoonsful+Twice+daily&Dispense
=600&refill=0 >Naproxen</A>

The an active guideline capable system, this hyperlink will create on the screen of the user a display which reads simply:

Naproxen

The balance of the information in the hyperlink is not displayed to the user, but is available to be passed to the order accumulator 26 if the user accepts the clinical guideline recommendation by invoking the hyperlink. The balance of the hidden information in the hyperlink is sufficient to instruct the medications function in the computerized patient records system to create a prescription for the recommended medication.

Another way to analyze this system is to consider what tasks each of the elements of the system are to perform. For example, the guideline server 12 is essentially a conventional web server containing the clinical guidelines in its storage device and making the pages stored in its storage device available to any inquiring processor by transmittal over the intranet, the internet 14, or other medium. The difference is that for each of the clinical guidelines, the guideline server 12 also includes an association to one or more tags. Each of the tags carries the information to both create a hyperlink in an active guideline capable web browser 22 as well as to convey the medical order, treatment or prescription information, and patient look back information to the computerized medical records system 16.

At the user end, the active guideline component of the electronic medical records system acts like a web browser in presenting the clinical guidelines to the users in a web page format. The user end processor also converts the tag into the hyperlink also presented to the user in association with the clinical guideline and retrieves the patient data relevant to the recommended orders. If the user invokes the recommendation in the clinical guideline by clicking on the hyperlink, the information in the hyperlink is sent to the order accumulator 26 for processing by the computerized patient record system. If the user selects links related to the patient record 32, the appropriate test results or medication data is accessed.

The result achieved by the active guideline system is that the use of the clinical guidelines at an entity can be integrated into the workflow of the clinicians using the system. In fact, once reference is made to the clinical guidelines, it becomes easier to follow the recommendations contained in the guidelines than doing anything else. The user simply has to click on the hyperlink associated with the guideline to accept the guideline and invoke the actions recommended by the guidelines. This ease of use will tend to foster the use and acceptance of such clinical guidelines across entities. In addition, the augmentation of the clinical guideline with patient data provides the clinician with relevant data that may impact the decision as to whether to follow the recommendations of the guideline without requiring the clinician to transition between the guideline and the patient record.

1. (canceled)

2. In a multiple server computer system operating an electronic medical records software system including a centralized repository of patient records and order entry in a healthcare institution, a method comprising the steps of
a) providing an active guidelines server, the active guidelines server maintaining a set of clinical guidelines and a set of active guidelines tags, each of the active guidelines tags being associated with at least one of the clinical guidelines and including information usable by an electronic medical records system to generate orders and retrieve patient data relevant to the clinical guideline;
b) providing an electronic medical records system including a centralized repository of patient data and an active guidelines viewer for access by a clinician, the active guidelines viewer including a web browser, an active guidelines interpreter and a URL router, the active guidelines interpreter and the URL router providing input to and monitoring output of the web browser, the active guidelines interpreter converting the active guidelines tags into a hyperlink for the web browser, the web browser displaying for the clinician the hyperlink associated with the clinical guideline and identified patient data corresponding to the clinical guidelines; and
c) when the clinician chooses a hyperlink presented by the web browser, the URL router receiving the active guideline tag associated with the chosen hyperlink and, if the chosen hyperlink is for an active guidelines order, sending a communication to the electronic medical records software system containing the stored order to cause an order to be entered and storing data from the active guideline tag in the electronic medical records system.

3. The multiple server computer system of claim 2, wherein the active guidelines tags further include a look back parameter identifying patient data to be retrieved.

4. The multiple server computer system of claim 2, wherein the active guideline interpreter parses the clinical guideline information and tags received from the guideline server to convert the embedded guideline tags into hyperlinks.

5. A computerized patient records system for use in a healthcare institution, the computerized patient records system comprising:
a clinical guidelines server storing clinical guidelines and active guideline tags, the active guideline tags correlating patient data related to the clinical guidelines;
an electronic medical records system, comprising:
a patient data component;
a medication data component;
an active guidelines interpreter in communication with the guideline server, the patient record component, and the medication data component; and
an active guideline viewer operable by a user to request display of a clinical guideline, wherein when the active guideline interpreter retrieves the clinical guideline and the corresponding active guideline tag, the active guideline interpreter parses the tag, retrieves the identified patient data, and provides a hyperlink for initiating an order for the patient and patient data related to the selected guideline, the hyperlink being operable by a user to initiate an order and to simultaneously store data related to the guideline in the patient record.

6. The computerized patient record system of claim 5, wherein the order is provided to an order accumulator.

7. The computerized patient record system of claim 5, wherein the order comprises at least one of a prescription for a medication and an order for a procedure for a selected patient.

8. The computerized patient record system of claim 5, wherein the tag further comprises a look back parameter identifying specific data to be retrieved for the corresponding clinical guideline.

9. In a computerized patient records system operated for a healthcare institution which maintains an electronic medical records system providing a centralized repository of patient records and written clinical guidelines, a method of operating active guidelines comprising the steps of
a) maintaining the clinical guidelines and active guideline tags corresponding to the clinical guidelines on an active guidelines server, the active guideline tags containing information useable by the electronic medical records system to generate orders corresponding to the clinical guideline;
b) receiving a request to view patient data;
c) generating a request to view a selected clinical guideline;
d) generating a request to retrieve a page associated with the clinical guideline;
e) retrieving a web page comprising the active guideline and active guideline tags corresponding to the selected clinical guideline;
f) converting the active guidelines tags to hyperlinks for initiating an order;
g) transmitting to the user the page comprising the hyperlinks;
h) receiving input from a user activating the hyperlink corresponding to the active guideline tag; and
i) transmitting data from the active guideline tag to the electronic medical records system to initiate the requested action and to store the tag in the centralized repository of patient records.

10. The method as recited in claim 9, wherein the tag identifies whether relevant data is to be gathered from the patient record, and further comprising the step of retrieving the patient data corresponding to a test procedure from the electronic medical records system.

11. The method as recited in claim 9, wherein the tag comprises the information to prescribe a medication for the patient, and the action comprises ordering a prescription.

12. The method as recited in claim 9, wherein the tag identifies whether at least one of a drug/drug and a drug/allergy verification check is to be performed on the patient record.

13. The method as recited in claim 9, wherein the tag identifies a procedure to be performed.

14. The method as recited in claim 9, wherein the tag identifies a CPT code for billing and insurance processing.

15. The method as recited in claim 9, wherein the tag verifies whether relevant data from the patient record should be gathered.

16. The method as recited in claim 9, wherein the tag includes a look back parameter identifying a length of time for a look back window.

17. The method as recited in claim 9, wherein the tag identifies an icon for display.

18. The method of claim 9, further comprising the step of displaying a look back window in a tooltip.

19. The method of claim 9, wherein the relevant patient data identifies tests performed on the patient.

20. The method of claim 9, wherein the hyperlinks include a test data link providing access to a full test report for the patient.

21. The method of claim 10, wherein the hyperlinks include a hyperlink to a recommended medication and the hyperlink to the recommended medication is highlighted to indicate an alert condition.
